(19) United States
(12) Patent Application Publication
(10) Pub. No.: US 2014/0128053 A1
(43) Pub. Date: May 8, 2014

(54) ACCESSING AND INTERACTING WITH WEB CONTENT AND SERVICES USING AN EXTERNAL DEVICE TO CONTROL A COMMUNICATION DEVICE

(71) Applicant: Moses Akbar Merchant, Fort Lee, NJ (US)

(72) Inventor: Moses Akbar Merchant, Fort Lee, NJ (US)

(21) Appl. No.: 14/113,613

(22) PCT Filed: Apr. 25, 2012
(86) PCT No.: PCT/US12/35014

§ 371 Date: Dec. 23, 2013

Related U.S. Application Data
(60) Provisional application No. 61/479,595, filed on Apr. 27, 2011.

(51) Int. Cl. H04W 4/00

(52) U.S. Cl. CPC H04W 4/005
USPC 455/419

(57) ABSTRACT

To access and interact with content and services over a network, such as the Internet, an external input device can be used to control a cellular phone or other communication device that provides connectivity to the network. A personal mobile Internet-enabled communication device may include a device driver component operable to receive a signal from an input device over a short-range wireless connection, wherein the signal is indicative that a particular shortcut key on the input device was actuated by a user. The personal mobile Internet-enabled communication device can include an Internet browser or media player, and an application call-out component operable to process the signal from the input device and pass a uniform resource locator to the Internet browser or media player based on the particular shortcut key which the signal indicated was actuated by the user. The Internet browser or media player receiving the uniform resource locator from the application call-out component is operable to communicate over a communications network with a particular online content or service provider depending on the particular shortcut key that was actuated. The communication device is operable to receive information from the online content or service provider and to present the information to the user.

### CROSS-REFERENCE TO RELATED APPLICATION(S)

This application claims the benefit of priority of U.S. Provisional Patent Application No. 61/479,595, filed on Apr. 27, 2011, the contents of which are incorporated herein by reference.

### FIELD OF THE DISCLOSURE

This disclosure relates to accessing and interacting with content and services over a network, such as the Internet, using an external input device to control a cellular phone or other communication device that provides connectivity to the network.

### BACKGROUND

Mobile communications technologies have proliferated globally during the past decade. For example, cellular phone carrier service is now available in many remote parts of the planet. Although a significant number of people, particularly in rural markets in developing countries, remain underserved with respect to Internet service, there is now a sizable populace in emerging markets that is increasingly sophisticated in the use of cellular phones and other electronic communication devices. Nevertheless, despite the greater accessibility to the Internet, a modicum of computer literacy still is required for most usage and functions. Some of the newer electronic communication devices are extremely powerful, but complex devices. Although users are increasingly aware of additional benefits of such devices, many of them do not understand or cannot operate all the features. They do not yet have extensive exposure to the Internet, and lack the wherewithal to explore the entire breadth of services available to them. Moreover, currently available cellular phones and other communication devices that offer connectivity to the Internet can vary significantly from one another in terms of functionality and user interface, and may use a wide array of different platforms. For some consumers, such variety presents a challenge and makes it difficult to use the communication devices effectively to access content and services over the Internet.

### SUMMARY

To access and interact with content and services over a network, such as the Internet, an external input device can be used to control a communication device that provides connectivity to the network.

According to one novel aspect, a method of accessing or interacting with content or services over a communications network includes receiving a signal in a communication device, wherein the signal is sent from an input device over a short-range wireless connection and is indicative that a particular shortcut key on the input device was actuated by a user. In response to receiving the signal in the communication device, the communication device communicates over the communications network with an online content or service provider that depends on the particular shortcut key that was actuated. Subsequently, information is received in the communication device from the online content or service provider, and the information is presented on a display screen of the communication device.

Some implementations include one or more of the following features. For example, in some implementations, actuating a particular shortcut key on the input device allows the user to specify an action to control input for a browser residing on the communication device. The communication device can be, for example, a personal mobile device.

In some implementations, in response to receiving the signal in the communication device, a software application residing on the communication device may dynamically construct a command and present it to the browser for execution. The command may comprise, for example, a uniform resource locator. In some implementations, a Bluetooth device driver in the communication device invokes the browser and sends to the browser the uniform resource locator. The input device and the communication device can be paired with one another to enable communications between them.

In another novel aspect, a method of accessing content or services over a communications network includes receiving a signal in a personal mobile communication device, wherein the signal is sent from an input device over a short-range wireless connection and is indicative that a particular one or more keys on the input device were pressed by a user. In response to receiving the signal in the communication device, a software application residing on the personal mobile communication device presents a first uniform resource locator to a browser on the communication device for execution, wherein the uniform resource locator depends on the particular one or more keys that were pressed by the user. The method includes receiving in the browser on the personal mobile communication device a redirect signal from an online service provider associated with the first uniform resource locator, wherein the redirect signal identifies a second uniform resource locator associated with another online content or service provider. The browser sends a request to the other online service or content provider. Subsequently, information is received in the personal mobile communication device from the other online content or service provider and the information is presented on a display screen of the communication device.

In some implementations, the signal from the input device comprises a code indicative of which one or more keys on the input device were pressed. The software application residing on the personal mobile communication device may, in some implementations, consult a lookup table to determine what action is to be taken in response to receiving the signal from the input device. In response to receiving the signal in the personal mobile communication device, the software application residing on the communication device may dynamically construct the first uniform resource locator and presents it to the browser for execution or a Bluetooth device driver in the personal mobile communication device may invoke the browser and send to the browser the first uniform resource locator. The second uniform resource locator identified in the redirect signal may, in some cases, depend on the one or more keys on the input device that were pressed by the user. The method may include capturing a device identifier, user identifier and/or location-based information in a uniform resource locator request from the browser, and delivering personalized content based on the captured device identifier, user identifier and/or location-based information.

According to another novel aspect, a method of accessing content or services over a communications network includes receiving a signal in a device driver of a personal mobile communication device, wherein the signal is sent from an input device over a short-range wireless connection and is indicative of a particular channel selected by a user. The method includes mapping the signal indicative of the particular channel to a particular application residing on the personal mobile communication device, and accessing a Web site at an online service provider, which provides a gateway or URL redirect service for a browser application on the personal mobile communication device.

In some implementations, the method includes receiving the signal in a Bluetooth device driver or an infrared device driver of the personal mobile communication device.

The disclosure also describes Internet-enabled communication devices. For example, in one novel aspect, a personal mobile Internet-enabled communication device includes a device driver component operable to receive a signal from an input device over a short-range wireless connection, wherein the signal is indicative that a particular shortcut key on the input device was actuated by a user. The personal mobile Internet-enabled communication device includes an Internet browser or media player, and an application call-out component operable to process the signal from the input device and pass a uniform resource locator to the Internet browser or media player based on the particular shortcut key which the signal indicated was actuated by the user. The Internet browser or media player receiving the uniform resource locator from the application call-out component is operable to communicate over a communications network with a particular online content or service provider depending on the particular shortcut key that was actuated. The communication device is operable to receive information from the online content or service provider and to present the information to the user.

One or more of the following features are present in some implementations. For example, the application call-out component can be operable to dynamically construct the uniform resource locator and present it to the browser or media player for execution. In some implementations, the device driver is a Bluetooth device driver. The personal mobile communication device can be paired with the input device to enable communications between them. The communication device may comprise, for example, a smartphone or mobile telephone.

According to another novel aspect, a personal mobile Internet-enabled communication device includes a device driver component operable to receive a signal from an input device over a short-range wireless connection, wherein the signal is indicative that a particular one or more keys on the input device were actuated by a user. The personal mobile Internet-enabled communication device also includes a software application, and an application call-out component operable to process the signal from the input device and present a first uniform resource locator to the software application based on the particular one or more keys which the signal indicated were actuated by the user. The first uniform resource locator is associated with a first online service provider, and the software application is operable to execute a URL request based on the first uniform resource locator. The software application is further operable to execute a second URL request based on a second uniform resource locator received in a redirect signal from the first online service provider, wherein the second uniform resource locator is associated with another online content or service provider. The communication device is operable to receive information from the other online content or service provider and to present the information to the user.

In some implementations, the software application comprises, for example, an

Internet browser, or a media player.

The methods, devices and systems described in this disclosure can make it easier for a user with an Internet-enabled communication device to access content and services, for example, over the Internet.

Other aspects, features and advantages will be apparent from the following detailed description, the accompanying drawings, and the claims.

### BRIEF DESCRIPTION OF THE DRAWINGS

FIG. 1 illustrates an example of a system according to a novel aspect of the disclosure.

FIG. 2 illustrates an example of a remote control device for use according to a novel aspect of the present disclosure.

FIG. 3 is a flow chart illustrating a method according to a novel aspect of the disclosure.

FIG. 4 illustrates an example of a user pressing a shortcut key on the remote control device.

FIG. 5 is an example of an administrator interface screen.

FIG. 6 is an example of another administrator interface screen.

FIG. 7 illustrates an example of a user pressing a channel guide or menu button on the remote control device.

FIGS. 8A and 8B illustrate examples of portal home pages that can be accessed through use of the remote control device.

FIG. 9 illustrates another example of a system according to a novel aspect of the disclosure.

FIG. 10 illustrates another example of a novel remote control device.

### DETAILED DESCRIPTION

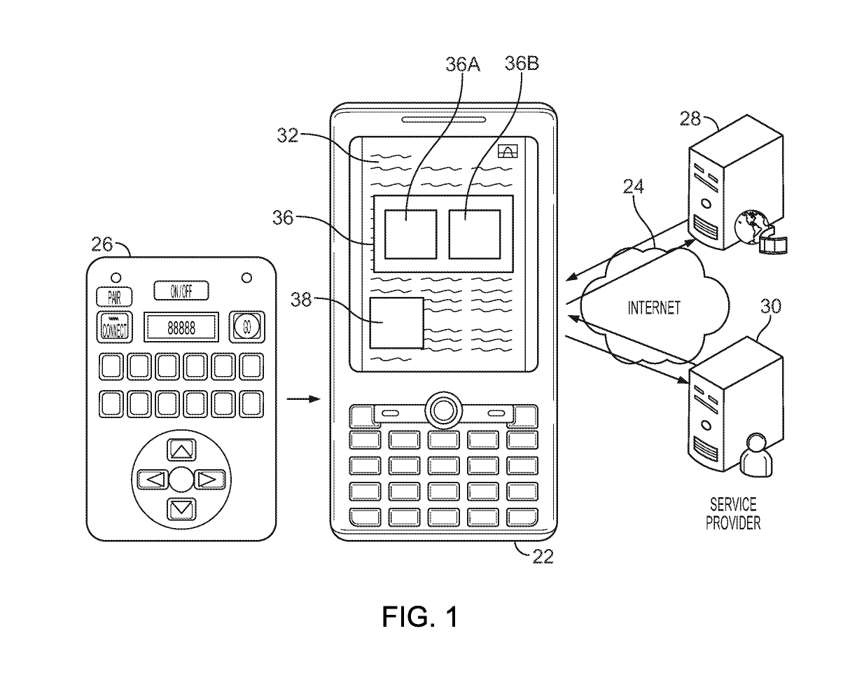

As shown in FIG. 1, a system includes a communication device 22 that provides connectivity to the Internet or other network 24. In the following discussion, it is assumed for the sake of illustration that the communication device 22 is a smartphone. However, in other implementations, the communication device may take other forms, such as a mobile handset phone, a tablet or notebook computer, a laptop computer, or some other personal computing device, including various handheld devices.

The illustrated smartphone (or other communication device) 22 is a network-enabled device that can execute application software such as an Internet browser to provide access to the Internet. In the illustrated example, the smartphone 22 includes a display screen 32 as well as a fully functional browser and standardized operating system platform with application development support. The smartphone 22 also includes an open application programming interface (API) for device driver application, such as Bluetooth communications protocols. Other implementations may use a different wireless technology standard (e.g., infrared-based) for exchanging data over short distances.

The application software can be invoked externally and controlled through a system that involves an external input device, interface software and a remote Internet or other server. The chain of command allows the application to be controlled from various points in the system. In the case of a browser, this means that content delivered to an end-user can be highly personalized and can be come from any source, for example, on the Internet. These features are possible because the communication device presents an open platform that allows for custom programming The application does not necessarily have to be a browser; for example, the application can be any inherent software or feature, or a combination of various applications built into the communication device. The subject matter described in this disclosure can provide a consistent and easy way to access such an application.

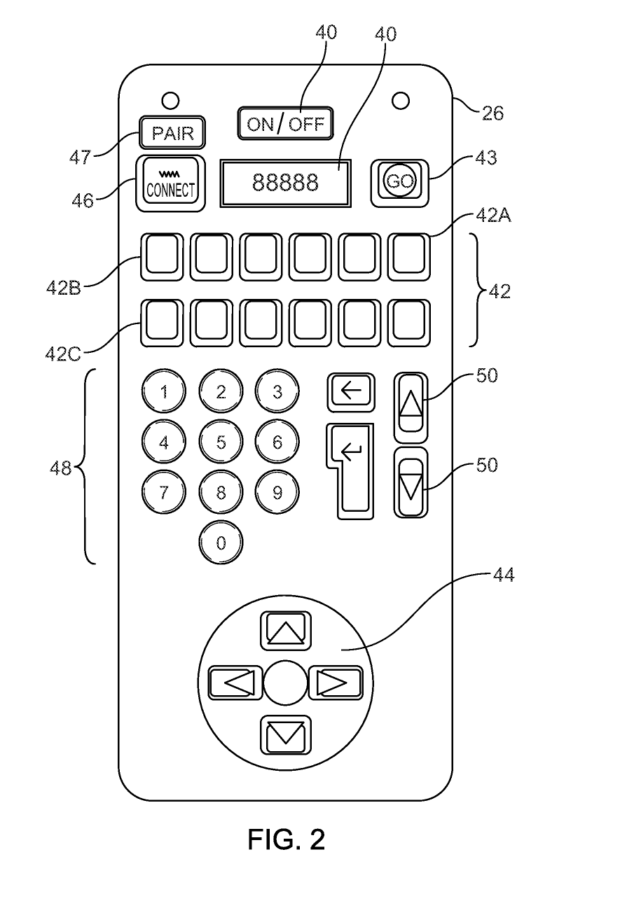

In the illustrated example, an input device 26, which allows the smartphone 22 to be controlled using a standardized interface, serves as a remote control device for the smartphone. In some implementations, the remote control device 26 communicates with the smartphone 22 through a short-range wireless connection, such as Bluetooth, with support for additional profiles if required, such as the Bluetooth HID profile. In some implementations, the remote control device 26 communicates with the smartphone 22 through other short-range wireless technologies (e.g., infrared) or through a wired connection (e.g., using a serial or USB cable). As shown in FIG. 2, the remote control device 26 may include an on/off power button 40. The remote control device 26 also may include one or more shortcut keys 42 (sometimes referred to as hotkeys) with a visible icon on each shortcut key to indicate the key's functionality. The remote control device 26 also can include a built-in mouse, track pad or other navigation keys 44.

A software application 36, which can be developed using the communications device's platforms and APIs, is installed on the smartphone or other communication device 22 and provides the ability to establish a Bluetooth (or other wireless) connection with the remote control device 26. For example, in some implementations, the software application 36 includes device driver software 36A, such as a Bluetooth device driver or an infrared device driver. The device driver software 36A can be used to establish the link with the remote control device 26. The software application 36 also can include application call-out software 36B to process signals received from the remote control device 26. This feature allows the remote control device 26 to interact with various software and applications on the smartphone through the use of the specially programmed shortcut keys 42 that can invoke certain software or a combination of applications in a pre-determined sequence or with pre-determined input data or configuration parameters. The applications invoked through this mechanism on the smartphone 22 can communicate, for example, with an online content or service provider to deliver content or services to the end-user. The shortcut keys 42 on the remote control device 26 allow for a series of complicated actions to be performed on the smartphone through simplified input actions. For example, the shortcut key actions can allow a media player or an Internet browser on the smartphone 22 to load specific content, pages or URLs from a predetermined Internet destination or Web portal site. Depending on the implementation, the content or services can be pre-defined, dynamic, interactive, personalized and/or on-demand and may be Web-based or delivered over the network 24 directly by a service provider 30 or through a third-party content/service provider 28.

In some implementations, the wireless link between the communication device 22 and the remote control device 26 can be established automatically after initial host configuration without requiring the user to enter a PIN. The software application 36 provides the ability to capture and interpret commands and hotkey actions performed by the end-user using the remote control device 26. In addition, the software application 36 provides the ability to invoke and interface with the browsing software (or media player) 38 on the smartphone 22. In response to receiving a signal from the remote control device 26 indicating that one of the shortcut keys 42 was pressed, the software application 36 dynamically constructs a command (e.g., a uniform resource locator (URL)) and presents it to the browser 38 for execution. The software application 36 also provides the ability to capture and parameterize device identifiers, user identifiers and/or location-based information in the URL request to allow for personalization of delivered content. In various implementations, the software application 36 can obtain such information from the device 26, the smartphone 22 or separately through user input.

The remote control device 26 includes a connect button 46, which can be pressed to establish initial Bluetooth connectivity with the software application on the smartphone 22. The remote control device 26 is able to identify itself uniquely to the software application 36 using the Bluetooth product identification or additional data elements in accordance with the communications protocol being used. The remote control device 26 also is able to relay end-user input commands to the software application 36 residing on the smartphone or other communication device 22 using standard Bluetooth protocols. The shortcut keys 42 and mouse, track pad or other navigation keys 44 on the remote control device 26 allow the user to specify actions that control elements of browser input and navigation. Instead of or in addition to the shortcut keys 42, some implementations of the remote control device 26 provide a channel selector feature. For example, there can be a numeric keypad 48 on the remote control device 26 along with an LED display to allow for a channel number to be entered and communicated to the Bluetooth device drivers 36A on the smartphone 22. Different channel numbers can be mapped to different applications by the device driver software 36A or produce a different set of pre-determined actions. In some implementations, different channel numbers are mapped to different Web sites (“Web Channels”) at an online service provider's 30 location, which offers a gateway or URL redirect service for a browser application on the smartphone. In some implementations, navigation keys 44 may be able to perform the task of switching between different channels, i.e., going up and down through a list of available channels, and/or displaying the next or previous URL or content available on a particular channel. Thus, the remote control device gives the user the ability to perform a wide range of controls normally present in a standard computer keyboard and the ability to support multiple types of communications devices (handsets) and platforms.

As further illustrated in FIG. 1, the system can include a third-party content or service provider 28, which can be accessed by the smartphone 22 over the Internet or other network 24. Although only a single third-party content/service provider 28 is shown in FIG. 1, a typical system can include many third-party content/service providers.

Some implementations also include a service provider 30, which can be, for example, a private or public online network service or Web portal site or online directory of Web sites and services that interfaces with the application 36 on the communication device 22. The service provider 30 can present a simple interface to the end-user, along with pre-programmed, redirected, end-user enabled or operator-assisted delivery of the requested content or services based on data, input or commands from the remote control device 26, application software 36 and/or the communications device 22.

Each of the content/service providers 28 and the service provider 30 can include a server system that includes one or more servers or processors and associated databases for storing information related to the content or services that are provided. In some implementations, they may be part of a cloud-based, or hosted, computing system. Cloud-based, or hosted, computing generally involves executing applications via a web browser, and obtaining information for the applications from a remote server system or service and involves the delivery of computing as a service whereby shared resources, software, and information are provided to computers and other devices as a utility over a network such as the Internet. Thus, cloud computing can make use of a set of pooled computing resources and services delivered over the web. Cloud computing can provide advantages over traditional desktop software, such as the ability to access documents from various different computers and locations.

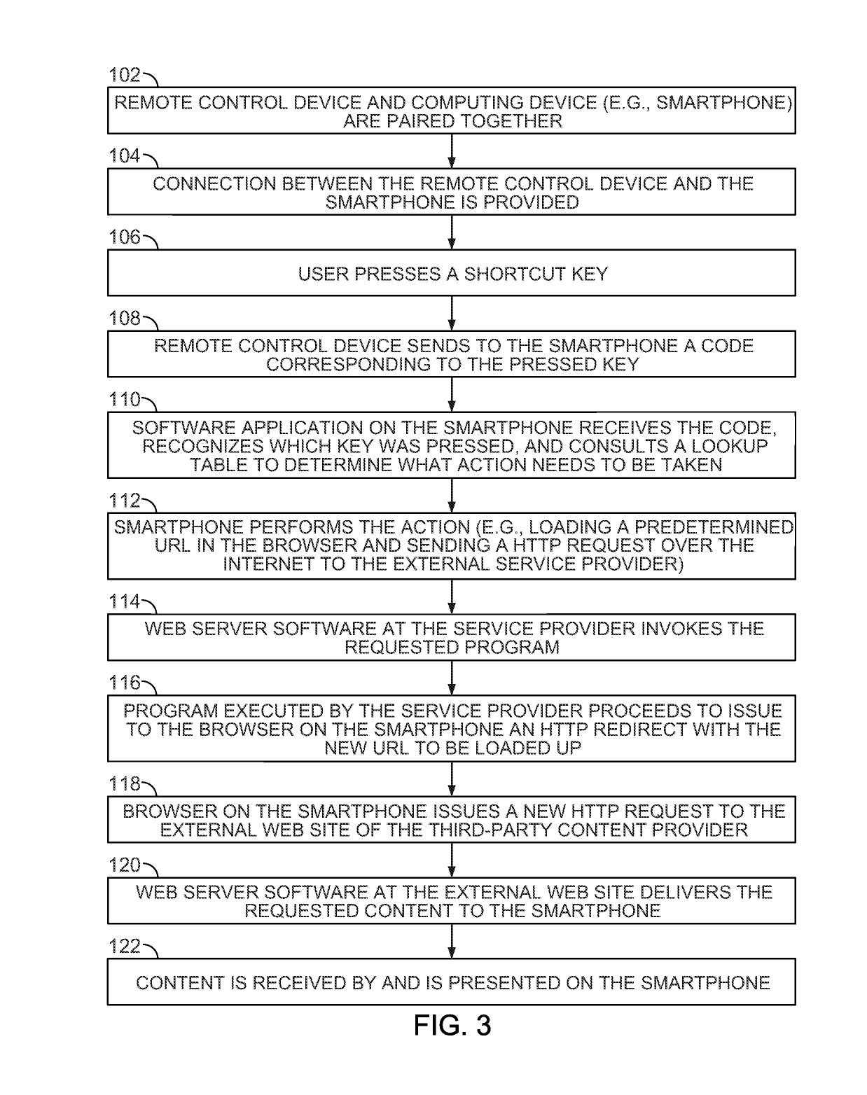

As illustrated by FIG. 3, when a user acquires a smartphone (or other communication device) 22 and a remote control device 26, the two devices need to be paired with one another to establish a trust relationship. In some implementations, the pairing process (block 102) includes enabling Bluetooth on the smartphone 22 through wireless configuration settings, switching on the remote control device 26 and pressing a “pair” key 47 on the remote control device 26, and/or setting an identical passkey (e.g., “1234”) that needs to be pressed on the smartphone 22 and the remote control device 26. Typically, the pairing process needs to be performed only once between any two devices 22, 26 and can originate at either one of the devices. Although the two devices are paired, there need not be a one-to-one correspondence between them. Thus, for example, the input device 26 can interface with more than one communication device 22.

To use the remote control device 26, a connection needs to be provided to the software application 36 on the smartphone 22 (block 104). This can be accomplished, for example, by clicking an icon that is associated with the application and displayed on the smartphone 22 (or otherwise invoking the application), clicking the connect button 46 on the remote control device 26, and proceeding to follow any instructions that are displayed on the smartphone 22. As the devices previously were paired, the connection process may happen automatically or may require the user to press the connect button 46, depending on the implementation. Once the remote control device 26 and software application 36 on the smartphone 22 are connected, the software application is able to capture and recognize signals indicating that a particular shortcut key 42 on the input device 26 has been pressed. In response, the software application 36 can perform a pre-determined or configurable action based on the key 42 that is being pressed.

In the illustrated example, the actions associated with the shortcut keys 42 can allow a media player or an Internet browser on the smartphone 22 to load specific content or Web pages or URLs from a pre-determined Internet destination or Web portal site. In a particular implementation, pressing shortcut key 42A, for example, causes a news page from a service provider's 28 portal site to be displayed on the smartphone 22 by having the Bluetooth device drivers invoke the browser application on the smartphone and sending it a predetermined or custom-constructed URL. Instead of content being delivered by a service provider 28, there may be a “landing page” delivered by the online service provider 30, which in turn can have links to other news sites. Likewise, pressing shortcut key 42B, for example, causes the latest music videos to be displayed on the smartphone 22 by programming the device driver software to invoke the media player application on the smartphone and then provide a URL link to a service provider's site, which in turn issues a redirect to Real-Time Streaming Protocol (RTSP) URL link for an external Internet media site. The navigational controls 44 on the input device 26 mimic or enhance the controls available on the smartphone 22 and offer a means to control the invoked application externally (e.g., navigational aspects in a Web browser or media controls in a media player).

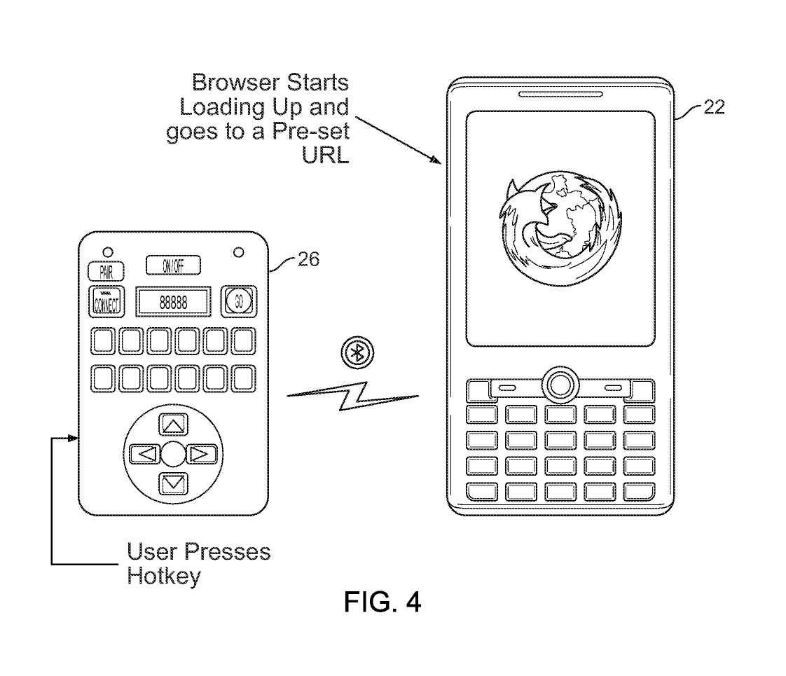

As an example, it is assumed that the user wants to obtain some current news over the Internet connection on her smartphone. The user knows that one of the shortcut keys on the remote control device 26 (e.g., key 42C) is the designated key for news. Thus, in this example, the user proceeds to press shortcut key 42C (block 106). Using the pre-established Bluetooth connection, the remote control device 26 sends to the smartphone 22 a code corresponding to the pressed key 42C (block 108). The software application 36 on the smartphone 22 receives the code, recognizes which key was pressed, and consults a lookup table to determine what action needs to be taken (block 110). The lookup table can be programmed, for example, within the software application 36 or stored within a data source or file on the smartphone 22. In this particular example, it is assumed that the action corresponding to the pressed key 42C is to load a pre-determined URL (e.g., http://www.service-provider.com/keypress_event.cgi?hotkey=6) in the browser. The software application 36 proceeds to invoke the browser software on the smartphone 22, which results in the browser application starting up if it is not already running, and passes the URL for loading to the browser, which then sends a standard HTTP request over its pre-established Internet connection to the external service provider 30 (block 112) (see FIG. 4).

In response to the HTTP request from the browser on the smartphone 22, Web server software at the service provider 30 invokes the requested program (block 114) associated with the appropriate parameters (e.g., hotkey=6, associated with shortcut key 42C). The program consults its own lookup table to determine the appropriate action that needs to be taken corresponding to the pressed shortcut key and what response needs to be sent back to the browser. In some implementations, instead of the program consulting a lookup table, the foregoing information is included in the program itself or in a database associated with the service provider 30.

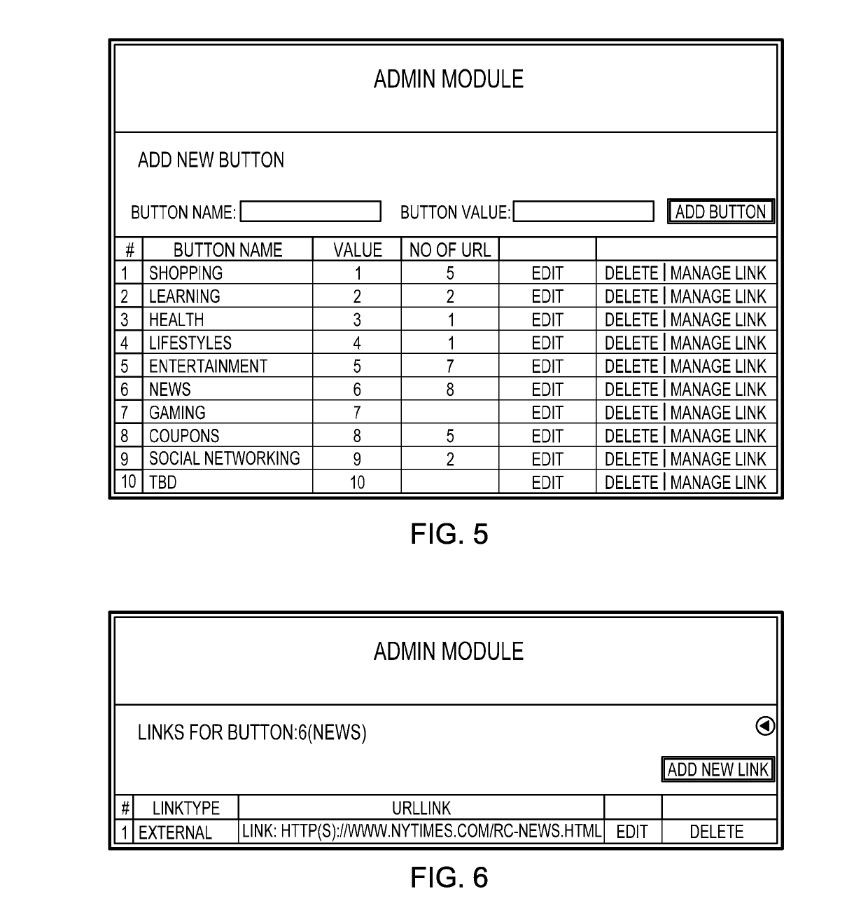

The action to be taken by the external service provider 30 can be controlled, for example, through a backend administrative interface at the service provider's site. This action may be to redirect the HTTP request to one of several URLs. As shown in the example of FIG. 5, an administrative module presents an interface screen 200 that lists the shortcut keys (i.e., buttons) available on the input device 26 in a first column and an associated name for each shortcut key in a second column. The number of URLs associated with each particular shortcut key is listed in another column. Where more than one URL is available, repeatedly pressing the same shortcut key 42 on the input device 26 allows the user to cycle through the different URLs. For example, shortcut key #6, which corresponds to shortcut key 42C in FIG. 2, allows the user to access any one of eight news URLS, content pages or sites. Each time the user presses this shortcut key, the system advances to a different URL from this list. As also shown in FIG. 5, an “Add” button allows an administrator or other user to add another shortcut key 42. By clicking entries in other columns, the administrator or other user can edit or delete information associated with one of the shortcut keys 42. As shown in FIG. 6, another screen presented by the backend administrative module can be accessed by the administrator or other user to manage the links (e.g., add, delete or edit one or more URLs) associated with a particular one of the shortcut keys 42.

In the illustrated example, the action to be taken based on the user having pressed the shortcut key 42C is to redirect the HTTP request to a predetermined external Web site URL, for example, a URL associated with a third-party content provider 28 that provides relevant news content. Thus, the program executed by the service provider 30 proceeds to issue to the browser on the smartphone 22 an HTTP redirect with the new URL to be loaded up (block 116). The browser on the smartphone 22 receives from the external service provider 30 the HTTP redirect with the new URL, and issues a new HTTP request to the external Web site of the third-party content provider (e.g., www.content provider.com) 28 (block 118). The Web server software at the external Web site 28 receives the HTTP request and, in turn, delivers the requested content to the smartphone 22 (block 120). The content is received by the smartphone browser and is presented on the smartphone (block 122).

The user can press other shortcut keys 42 on the input device 26 to receive additional or alternate types of content, or invoke other actions on the smartphone 22. When the user presses one of the shortcut keys 42, the process continues at step 108.

In some implementations, the external service provider 30 serves as a Web portal site that provides a list of categories and a Web landing page for each of the categories with a list of links (URLs) to online sites and services for that category, along with the ability for a user to navigate through the list using the remote control device 26. The remote control device 26 also can include simple navigational controls 44, which allow the user to scroll through the list of sites on a displayed Web page and select a site for viewing.

In some implementations, links on the landing pages can be listed, or otherwise associated, with channel numbers. A HTML forms element box on each page can be provided to allow the user to enter the channel number from the remote control device 26. For example, channel “101” may lead to a first content provider's Web site and channel “102” may bring up a second content provider's Web site.

A Web channel mechanism allows a user to enter channel numbers on the remote control device 26 so as to access a Web site URL via the smartphone 22. For example, a user can enter a channel number on the numeric channel selector keypad 48 on the remote device 26. Alternatively, in some implementation, the user can use up/down arrow keys 50 to scroll through displayed channel numbers and select a desired channel number to be entered. As with the specially programmed shortcut keys 42, this Web channel surfing mechanism interfaces with the application software 36 on the smartphone 22, which, in turn, starts up the browser or multimedia player (if it is not already running) and loads up the requested Web media, content or service based on the user input. The actual mapping of the user input to the requested content or service can be handled dynamically by Web services at the service provider 30.

As an example, in response to the user entering a channel number, the application software 36 being executed on the smartphone 22 captures the channel number based on the input entered by the user on the remote control device 26. The application 36 then proceeds to detect whether the browser (or media player) application 38 already was running on the smartphone and, if not, it starts up the browser application (or media player). If the browser application 38 already was running, it is brought into the foreground. The application 36 creates a URL based on the Web site address of the service provider 30, with the channel number as one of the parameters, and device-specific information as another parameter. The software application 36 then passes the URL to the browser application 38, which, in turn, issues the request to the service provider 30. The service provider 30 interprets this request and determines a course of action based on the channel number and other parameters. For example, the service provider 30 can consult a mapping database on its backend servers to determine a new Web site address or URL, which is sent back to the browser 38 on the smartphone as a HTTP redirect call. The browser 38, in turn, automatically issues a new call to the redirected Web site associated with the third-party content/service provider 28 to load up the new URL so that the content or service requested by the user is presented on the smartphone screen 32.

Depending on the implementation, the service provider 30 may provide a standard redirect link based on the user request, or rotate the redirect links, or provide a custom redirect based on HTTP cookies, a unique input device identifier, or another end-user identifier passed as a URL parameter, in order to present fresh content associated with the shortcut key 42 or the channel number entered by the user using the remote control device 26.

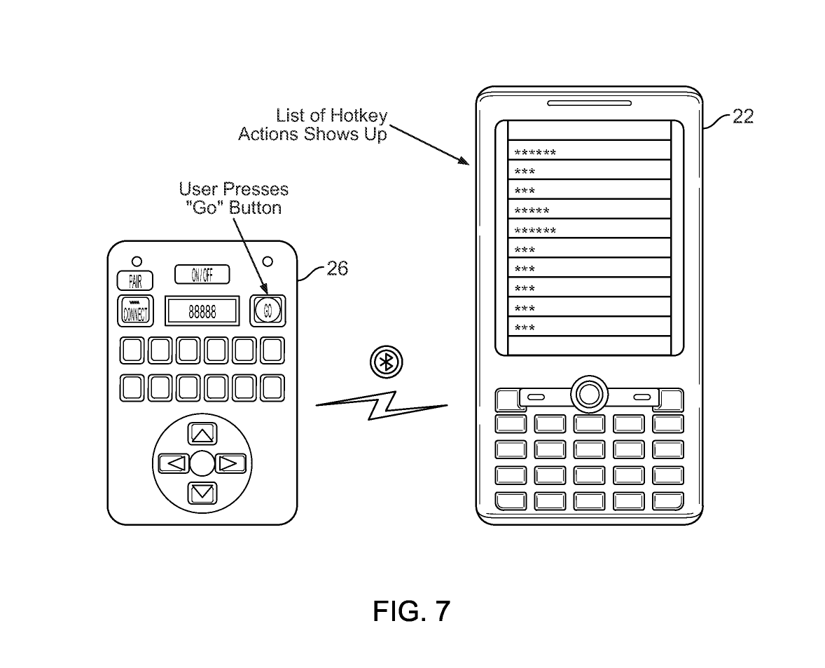

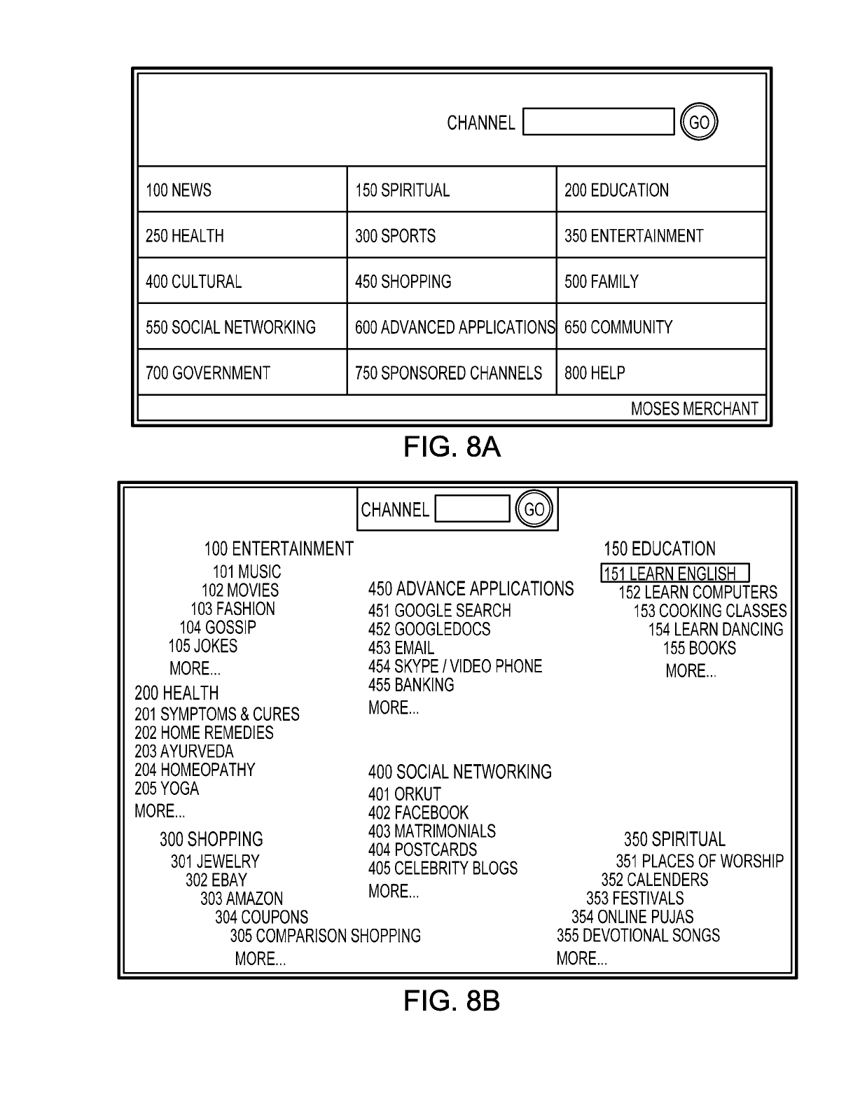

A special hotkey, such as a channel guide or menu button (also referred to in this disclosure as a “Go” button) 43 on the remote control device 26, invokes the browser with the URL of the home page of the portal site so as to display on the smartphone or other communication device 22 a list of subject categories or other actions corresponding to the various shortcut keys 42 (see FIGS. 7, 8A and 8B). Regardless of what site a user is surfing on the Internet, pressing the Go button 43 brings back the menu of site links or categories. Thus, the Go button 43 allows the user to obtain information about the content or types of content available by pressing one of the other keys 42.

The combination of the shortcut keys 42 and the Web channel interface, the Bluetooth drivers 36A, along with an easily configurable backend Web service at the portal site, presents a powerful mechanism for controlling the content that is delivered to end-users. This allows for building sophisticated applications, and employing location-based services, device identifiers and session management through HTTP cookies to provide a high degree of personalization. Having a separate remote control 26 that functions as a keyboard input device provides an easy-to-use and consistent interface that is independent of the keypad and browser software controls on the smartphone or other communication device 22. End-users can access a wide variety of useful and relevant content across the entire spectrum of the World Wide Web.

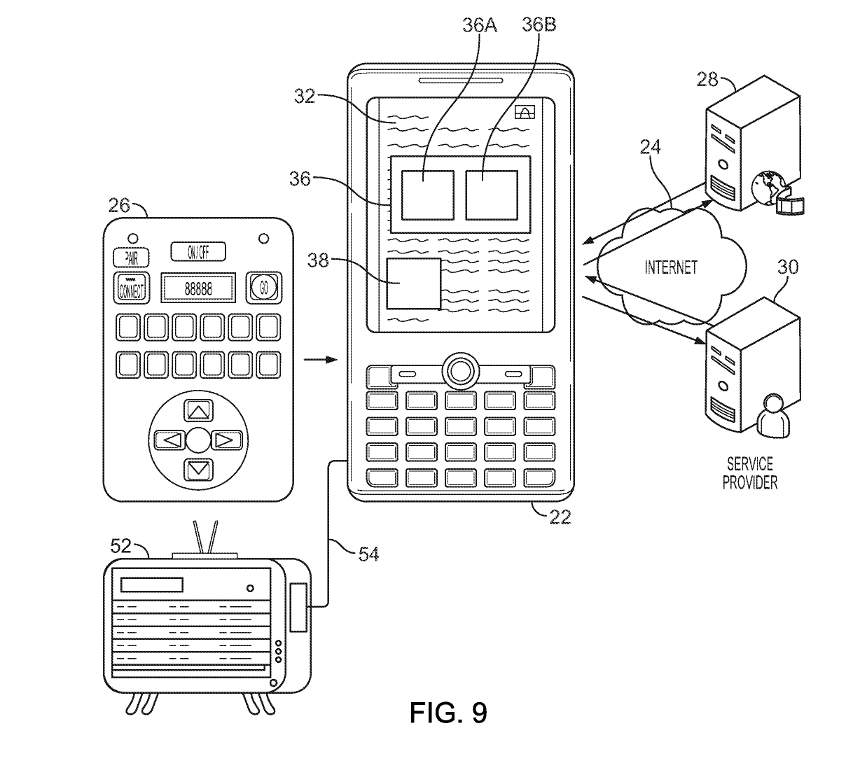

In some implementations, as shown in FIG. 9, the smartphone or other communication device 22 can be connected to a separate display (e.g., a TV set) 52 by way of standard AV cables 54. Such implementations allow the received content to be presented on a larger display 52 as well as on the smartphone screen 32. Thus, for example, if the smartphone 22 has an AV jack that is connected to the television set 52, the externally attached display mimics the contents shown on the screen 32 of the smartphone. Enhanced display drivers can be provided for the smartphone 22 to simulate a large virtual screen for the browser. This, in turn, drives the external AV output to the larger, attached display 52, thereby maximizing the real-estate afforded by the larger display. Alternatively, browser software and configurations on the smartphone 22 can be adjusted to optimize output for the attached display and to facilitate the display of features that otherwise might not be visible on the small smartphone screen 32. The display driver software 36A also can interface with a track pad having advanced pinch-zoom capabilities for controlling the screen size. Thus, with a powerful Internet-capable smartphone (or other computing device) 22 and basic applications being delivered over the Web, the system can provide an environment similar to a desktop computer with the application software 36 running on the smartphone (or other computing device) 22, and the addition of a fully-functional Bluetooth input device 26 and TV-connector cable 54. In such implementations, the input device 26 can be, for example, an enhanced version of the input device described above in FIG. 2, with QWERTY-style alphabet keys and other controls typically found on a standard PC keyboard.

As an example of the foregoing capability, the keypad 48 or shortcut keys 42 can be used to alternate between different virtual desktop environments provided over an Internet cloud. For instance, in a particular implementation, a first shortcut key 42 may present a Microsoft Windows™-based desktop environment, whereas a second shortcut key 42 may present a Linux-based desktop environment. The different environments can be used for executing different applications, or for testing applications on different computing platforms.

Some implementations allow for the creation and use of personal channels, which allow end-users or third-party service providers to map, distribute and advertise access to their own Web channels. The mapping of the Web channels can be implemented, for example, by requesting the mapping from the service provider 30 or obtaining direct access to the service provider's backend infrastructure. In some cases, an individual can map a Web site URL to her own private Web channel, so as to create a sharable personal channel. As an example, a user can set up a personal channel pointing to her on-line photo album, and distribute the channel number to her friends and family for easy access. Similarly, independent content providers and aggregators (e.g., video content producers), who currently rely on free sites and viral marketing efforts for distribution, can map their content to personal channels, and can advertise and distribute the channel number, thereby creating another outlet with a potentially large new audience to promote their content.

In some implementations, third-party service providers can create personal channels for their customers to provide personal, interactive and on-demand Web services. End-users can call in with their requests and can be directed to their own personal channels. Examples of such services are bill presentation and payment services (e.g., by utility providers), personal search services, personal content delivery services, video on-demand services, and personal gaming station services.

The examples of personal channels and services mentioned above, as well as others, can be enabled on-the-fly and on-demand through the system's backend interface. The input devices described above make it easy for any novice user with a smartphone or Internet-enabled communication device to access Web content promoted through this mechanism. The channels can be made available through the service provider's portal site to anyone with a computer and Internet connection.

In some implementations, the system utilizes the inherent capabilities of the communication device 22, such as built-in camera or phone capabilities, to capture end-user input and interactions in a variety of ways in addition to the input device 26. The system can interface, for example, with various Internet and Web services via audio and visual commands and cues, instead of just through a keyboard or remote control input device. Corresponding systems and servers at the service provider 30 (e.g., Web servers, IVR systems) can interpret multiple input data streams and service requests from the end-user.

Using the disclosed systems and techniques, content and applications can be changed at a moment's notice, based on popularity, populace and individual profiles. Various different devices can be used as the input device 26 to access different categories of content. Examples of this include e-learning, e-commerce, applications store shortcuts, and promotional devices.

As an example of e-learning applications, the input mechanisms can provide access to various sites with multimedia content to enable e-learning. Personal channels in such an environment allow for establishing an exchange or marketplace for tutors and potential students.

As an example of e-commerce applications, the input mechanisms can provide access to various e-commerce sites, shopping-comparison sites and transaction-based services. Special hotkeys can be programmed to obtain coupons, display daily deals and enable the transaction. Additionally, the input device 26 can be used to pay for premium Web content.

As an example of an applications store shortcuts, the input mechanisms can provide access to the applications stores of choice for the platform and can provide shortcuts to download and install popular applications on the communication device 26.

As an example of promotional devices, the input mechanisms can provide access, for example, to previews of a new movie being released, or stream snippets of a new music album. Likewise, the input mechanisms can pull up content sponsored by a corporate or political entity. Local services also can be promoted and consumed through this mechanism, using the geo-coordinate location parameters of the communications device 26.

The input device 26 can take various forms having different physical characteristics (shapes, sizes and colors) and different capabilities to facilitate interaction with the communication device 22 for specific functions and applications. In some embodiments, the input device 26 is implemented as a remote wireless keyboard. Other implementations of the input devices 26 include a multimedia remote control that uses a limited number of buttons and a joystick to turn the set-up into a multimedia/gaming console, a small input device with a limited number of hotkeys and “answer” keys (e.g., “Yes” and “No” buttons) for end-users to participate in surveys, polls and quizzes or sweepstakes/lottery applications, which can be administered in conjunction with third party sponsors, an input device co-branded by a corporate entity to display content relevant to its organization, a small numeric keypad with minimal controls to provide a video-phone application, or a virtual keyboard device with on-screen controls (e.g., an LED-based touch screen) that changes based on the application being used, hotkeys implemented on a watch or other accessory.

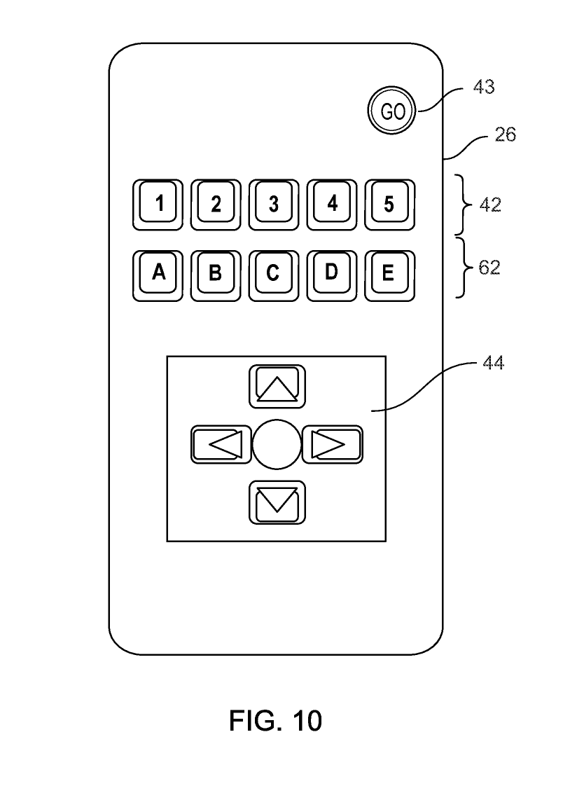

In addition to the shortcut or hotkeys 42, the navigation keys 44, the arrow keys 50, and various other button described above, some implementations can include function keys 62, as shown in the example of FIG. 10. Function keys 62 can perform functions such as saving, deleting or replaying selected content and posting it, for example, to a social networking site or otherwise sharing it with other users.

Some input devices 26 may allow an end-user to program the shortkey actions by changing the association of the content on the system's backend. In this manner, a user can associate each shortkey 42 with user-specified types of content or services such that each particular shortkey 42 is associated, for example, with a website for the delivery of news or other type of specified content, instead of being associated with default pre-programmed sites.

In some implementations, the input device 26 may have additional features integrated into it to allow for user authentication through the use of biometric or other personal information, which can be used to support, for example, electronic transactions.

The smartphone (or other communication device) 22 may support other software applications in addition to, or instead of, a browser. Like the browser application, the other software applications can reside on the communications device 22 and can be invoked, for example, based on the particular shortkey 42 pressed by the user of the input device 26.

The various shortkeys 42, as well as other keys and buttons on the input device 26, may serve different purposes or provide different functions, depending on the particular application that is being invoked by the communications device 22. Thus, for example, there may be multiple input devices 26 to interface with special software applications provided by the service provider 30 (e.g., e-commerce, e-learning, e-health, gaming and social networking). In some implementations, the input device 26 may feature special functions or elements, such as prominent hotkeys, to simplify control of the communications device 26, or to interface with any special applications.

Depending on the implementation, the content and services may be available internally on the service provider's 30 systems, or through external sites and third-party providers 28 of services. Thus, in various implementations, the service provider 30 may link to the external sources 28, may redirect end-user requests to the external sources 28, or may act as a proxy for such external sources 28 (i.e., such that all requests to the third-party providers 28 as well as the content and services from the third-party providers 28 flow through the service provider 30). The service provider 30 may, in some implementations, provide end-users with the ability to access content and services not explicitly available through the directory listing by adding or enabling the requested item on-demand, and providing private personal channels or bookmarked channels for access. In various implementations, the ability of programming and enabling personal channels or new channels and services may be available directly to the end-users and third-party service providers, or may be provided as an operator-assisted facility.

In some implementations, end-users may have the ability to save their respective channel configurations, profile data, and preference settings, for example, by using an appropriate one of the function keys 62 (FIG. 10). The service provider 30 can provide specific applications or other unique services, some of which may be based on the capabilities of the communications device 22 and/or the input device 26.

The specific application residing on the communications device 22 with which the input device 26 interacts can be, for example, a personal computer which interacts with a cloud computing system. Such a configuration can allow for providing multiple and different desktop computing environments to the end-user. The specific applications may be interactive applications that take advantage of the communications device's 26 inherent capabilities (e.g., camera and phone) to capture and relay video and audio data back to the service provider (e.g., video-phone, interactive games and quizzes, one-on-one interactions for various services such as tutoring, etc.).

The specific application residing on the communications device 22 may provide for content to be filtered through a translation engine by the service provider 30 before delivery, thus allowing end-users to access the content in a language of their choice. The specific application can be, for example, sponsored channels, which can allow third-party content providers to provide personal programming, and on-demand content and services, such as bill-payment systems, service or travel booking systems, polls, surveys, etc. through the web-channel mechanism.

Other implementations are within the scope of the claims.

1. A method of accessing or interacting with content or services over a communications network, the method comprising:
receiving a signal in a communication device, wherein the signal is sent from an input device over a short-range wireless connection and is indicative that a particular shortcut key on the input device was actuated by a user;
in response to receiving the signal in the communication device, causing the communication device to communicate over the communications network with an online content or service provider that depends on the particular shortcut key that was actuated; and
subsequently receiving information in the communication device from the online content or service provider and presenting the information on a display screen of the communication device.

2. The method of claim 1 wherein actuating a particular shortcut key on the input device allows the user to specify an action to control input for a browser residing on the communication device.

3. The method of claim 1 wherein in response to receiving the signal in the communication device, a software application residing on the communication device dynamically constructs a command and presents it to the browser for execution.

4. The method of claim 3 wherein the command comprises a uniform resource locator.

5. The method of claim 4 wherein a Bluetooth device driver in the communication device invokes the browser and sends to the browser the uniform resource locator.

6. The method of claim 3 wherein the input device and the communication device previously were paired with one another to enable communications between them.

7. The method of claim 3 wherein the communication device is a personal mobile device.

8. A method of accessing content or services over a communications network, the method comprising:
receiving a signal in a personal mobile communication device, wherein the signal is sent from an input device over a short-range wireless connection and is indicative that a particular one or more keys on the input device were pressed by a user;
in response to receiving the signal in the communication device, causing a software application residing on the personal mobile communication device to present a first uniform resource locator to a browser on the communication device for execution, wherein the uniform resource locator depends on the particular one or more keys that were pressed by the user;
receiving in the browser on the personal mobile communication device a redirect signal from an online service provider associated with the first uniform resource locator, wherein the redirect signal identifies a second uniform resource locator associated with another online content or service provider;
causing the browser to send a request to the other online service or content provider; and
subsequently receiving information in the personal mobile communication device from the other online content or service provider and presenting the information on a display screen of the communication device.

9. The method of claim 8 wherein the signal from the input device comprises a code indicative of which one or more keys on the input device were pressed.

10. The method of claim 9 wherein the software application residing on the personal mobile communication device consults a lookup table to determine what action is to be taken in response to receiving the signal from the input device.

11. The method of claim 8 wherein in response to receiving the signal in the personal mobile communication device, the software application residing on the communication device dynamically constructs the first uniform resource locator and presents it to the browser for execution.

12. The method of claim 8 wherein in response to receiving the signal in the personal mobile communication device, a Bluetooth device driver in the personal mobile communication device invokes the browser and sends to the browser the first uniform resource locator.

13. The method of claim 8 wherein the input device and the personal mobile communication device previously were paired with one another to enable communications between them.

14. The method of claim 8 wherein the second uniform resource locator identified in the redirect signal depends on the one or more keys on the input device that were pressed by the user.

15. The method of claim 8 including:
capturing a device identifier, user identifier and/or location-based information in a uniform resource locator request from the browser; and
delivering personalized content based on the captured device identifier, user identifier and/or location-based information.

16. A method of accessing content or services over a communications network, the method comprising:
receiving a signal in a device driver of a personal mobile communication device, wherein the signal is sent from an input device over a short-range wireless connection and is indicative of a particular channel selected by a user;
mapping the signal indicative of the particular channel to a particular application residing on the personal mobile communication device; and
accessing a Web site at an online service provider, which provides a gateway or URL redirect service for a browser application on the personal mobile communication device.

17. The method of claim 15 including receiving the signal in a Bluetooth device driver of the personal mobile communication device.

18. The method of claim 15 including receiving the signal in an infrared device driver of the personal mobile communication device.

19. A personal mobile Internet-enabled communication device comprising:
a device driver component operable to receive a signal from an input device over a short-range wireless connection, wherein the signal is indicative that a particular shortcut key on the input device was actuated by a user;
an Internet browser or media player;
an application call-out component operable to process the signal from the input device and pass a uniform resource locator to the Internet browser or media player based on the particular shortcut key which the signal indicated was actuated by the user;
wherein the Internet browser or media player receiving the uniform resource locator from the application call-out component is operable to communicate over a communications network with a particular online content or service provider depending on the particular shortcut key that was actuated; and
wherein the communication device is operable to receive information from the online content or service provider and to present the information to the user.

20. The communication device of claim 19 the application call-out component is operable to dynamically construct the uniform resource locator and present it to the browser or media player for execution.

21. The communication device of claim 19 wherein the device driver is a Bluetooth device driver.

22. The communication device of claim 19 wherein the personal mobile communication device is paired with the input device to enable communications between them.

23. The communication device of claim 19 comprising a smartphone or mobile telephone.

24. A personal mobile Internet-enabled communication device comprising:
a device driver component operable to receive a signal from an input device over a short-range wireless connection, wherein the signal is indicative that a particular one or more keys on the input device were actuated by a user;
a software application; and
an application call-out component operable to process the signal from the input device and present a first uniform resource locator to the software application based on the particular one or more keys which the signal indicated were actuated by the user, wherein the first uniform resource locator is associated with a first online service provider;
wherein the software application is operable to execute a URL request based on the first uniform resource locator, the software application further being operable to execute a second URL request based on a second uniform resource locator received in a redirect signal from the first online service provider, wherein the second uniform resource locator is associated with another online content or service provider, and wherein the communication device is operable to receive information from the other online content or service provider and to present the information to the user.

25. The communication device of claim 24 wherein the software application comprises an Internet browser.

26. The communication device of claim 24 wherein the software application comprises a media player.

27. A system comprising:
an input device comprising a plurality of actuatable keys and able to communicate using a short-range wireless connection;
a personal mobile Internet-enabled communication device paired with the input device;
a first online service provider; and
a second online content or service provider;
wherein the communication device comprises:
a device driver component operable to receive a signal from an input device over a short-range wireless connection, wherein the signal is indicative that a particular one or more of the keys on the input device were actuated;
a software application; and
an application call-out component operable to process the signal from the input device and present a first uniform resource locator to the software application based on the particular one or more keys which the signal indicated were actuated, wherein the first uniform resource locator is associated with the first online service provider;
wherein the software application is operable to execute a URL request based on the first uniform resource locator, the software application further being operable to execute a second URL request based on a second uniform resource locator received in a redirect signal from the first online service provider, wherein the second uniform resource locator is associated with the second online content or service provider, and
wherein the communication device is operable to receive information from the second online content or service provider and to present the information.

28. A method of accessing or interacting with content or services over a communications network, the method comprising:
receiving a signal in a smartphone, wherein the signal is sent from an input device over a short-range wireless connection;
recognizing, by an application in the smartphone, that a particular shortcut key on the input device was actuated by a user;
causing the smartphone to communicate over the communications network with a particular content or service provider depending on the recognized shortcut key; and
subsequently receiving, in the smartphone, streamed music from the particular content or service provider.

29. The method of claim 28 further including receiving an additional signal in the smartphone, the additional signal being generated at the input device in response to a user actuating a navigation key on the input device, the additional signal representing an action that controls an aspect of a streaming content experience via the smartphone.
